(19) United States
(12) Patent Application Publication
(10) Pub. No.: US 2010/0043024 A1
(43) Pub. Date: Feb. 18, 2010

(54) CHANNEL SWITCHING MODULE

(75) Inventors: WEI-CHIN HUANG, Sanchong City (TW); HUI-JU YU, Sanchong City (TW)

Correspondence Address: MANA DIGITAL CORPORATION, P.O.BOX 108-00403, Taipei, 106, omitted

(73) Assignee: MANA DIGITAL CORPORATION, Sanchong City (TW)

(21) Appl. No.: 12/192,141

(22) Filed: Aug. 15, 2008

(51) Int. Cl. G06F 3/00

(52) U.S. Cl. 725/38

(57) ABSTRACT

A channel switching module is disclosed. The channel switching module includes a server host, an audio/video player and a display device. The server host has a controller for respectively connecting and controlling an audio/video processor, a signal transmission module and a channel switching unit, wherein the audio/video processor encodes/decodes to the internal audio/video files, and the channel switching unit switches channels, and the signal transmission module transmits out a selected audio/video signal. The audio/video player has a signal transmission module for receiving the audio/video signal transmitted by the server host and a controller for connecting and controlling an executing unit and a display device for playing.

### BACKGROUND OF THE INVENTION

1. Field of the Invention

The present invention relates to a channel switching module. More particularly, the present invention relates to a channel switching module capable of switching the channel after receiving an error signal by the server host from the audio/video player in order to prevent problems due to no signal to display constantly in the display device.

2. Description of Related Art

The TV revolution entails from the earlier black-white and color CRT TV to the latest LCD and plasma TV with improved display quality, higher resolution, better contrast and brighter color. Correspondingly, the number of the channels is also increased from a few to a plenty, and the TV signal transmission method is being upgraded from the analog to the latest digital format.

The present signal transmission method of the TV display device, regardless of analog signal or digital signal, is in a particular mode, for example, the TV display has to be connected to the transceiver through a signal cable for receiving images and sound signals; and the computer display has to be connected to the computer host for displaying the processed data. Along with the improvement of the computer display, the computer host can be connected with each other through the internet for transmitting/receiving remote signals; and the user can even process online video communication with the cyber video camera displayed in the computer display device.

Because the multimedia is widely used, the consumers can view the commercial information or news anytime and from anywhere, for example, department store, shopping mall or 3C market, all have the promotion windows to stimulate the consumers' shopping desire.

Furthermore, conventionally all types of video signal transmission was conducted with the wired interface. Presently, the latest popularly used signal transmission method is wireless transmission including a rear terminal host, for example DVD player or computer, for transmitting the audio/video signal to the controller, and a built-in radio signal emitting module of the controller for transmitting the signal to a display device of another terminal for displaying. Thus, the external cable is not essential and the wiring cost can be reduced, and also the living quality can be improved accordingly.

However, the above controller with wireless transmission function has the following defects.

1. The user or the manager cannot switch the channel from the display terminal, and therefore, if the commercial film or the TV program cannot be displayed normally, the user or the manager has to inform the control room through the telephone or the radio to reset the display or trouble elimination. Such kind of one-way control method for the wireless audio/video system is inconvenient for the manager or the controller.

2. As mentioned above, if the user or the manager cannot deal with the display problem on time, the user still has to pay for the blank channel, and therefore it is uneconomical for the users.

3. There are many categories of users with various shopping hobbies and financial capabilities. Besides, the female and male consumers have different preferences, and the channel cannot be switched to the desired channel to meet the requirement of the present viewer on time, thus the time for the viewers spend in front of the display device will be accordingly too short to bring out the purchase desire. In other words, the commercial activity thereby is not effective.

Therefore, how to overcome the defect of the conventional design is an important issue for the manufacturer in the field.

### SUMMARY OF THE INVENTION

Accordingly, the present invention provides a channel switching module.

According to an aspect of the present invention, a sever host comprises a controller to control an audio/video processor for processing encoding and decoding to a plurality of audio/video files, and a signal transmission module for transmitting the selected audio/video signal. An audio/video player comprises a signal transmission module for receiving the audio/video signal transmitted from the server host to further display in a display device connected to an executing unit in the audio/video player. If an error detecting module of the audio/video player detects that an error occurred, an error detecting feedback module of the server host receives the error signal and reports to the controller to enable the channel switching module to automatically switch the present channel to an available one. Thus, the server host can switch the channel to the valid one automatically when the present channel played in the displayer device is not functioning, in order to keep the channel playing constantly.

According to another aspect of the present invention, the audio/video player comprises a camera module for capturing the image of the viewer standing in front of the display device to further transmit the image to the controller of the server host for processing identification. Next, the channel switching module switches the channel according to the viewer's age, sex, height or other features for providing the classified advertisement or program to the specific viewer. Thus, the commercial activity in the display device can be more effective.

According to another aspect of the present invention, server host comprises a data memory module to record the number of the image captured by the camera module of the audio/video player and the switching frequency of the channel switching unit of the server host to gain the reference figure of the viewer population and other related data for the market survey.

### BRIEF DESCRIPTION OF THE DRAWING

For a more complete understanding of the present invention, reference will now be made to the following detailed description of preferred embodiments taken in conjunction with the following accompanying drawings.

FIG. 1 is a view of a system according to a preferred embodiment of the present invention.

FIG. 2 is a view of a system according to another preferred embodiment of the present invention.

### DETAIL DESCRIPTION OF THE INVENTION

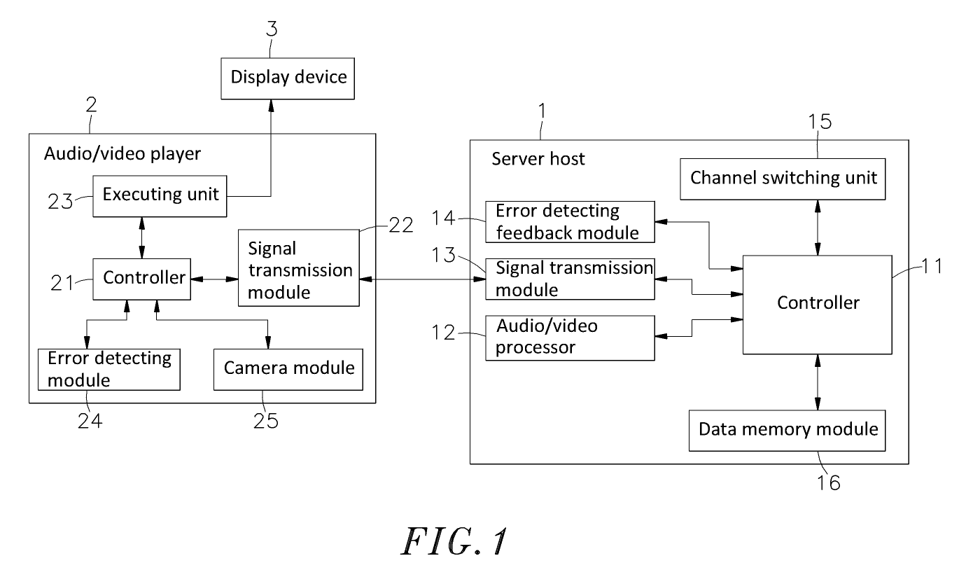

FIG. 1 is a view of a system according to a preferred embodiment of the present invention. Referring to FIG. 1, a channel switching module comprises a server host 1, an audio/video player 2 and a display device 3.

The server host 1 comprises a controller 11 respectively connected to an audio/video processor 12, a signal transmission module 13, an error detecting feedback module 14, a channel switching unit 15 and a data memory module 16. The controller 11 is a control unit of the server host 1 for receiving the user's command to command the audio/video processor 2 to encode/decode the internal audio/video files and to send out via the signal transmission module 13. Besides, the signal transmission module 13 may transmit the user's select command, for example, the user presses the button of the remote controller to directly adjust the channel or the volume, or other TV or audio/video signal. The error detecting feedback module 14 can receive the error detecting signal transmitted from the audio/video player 2 and reports to the controller 11 to enable the channel switching unit 15 to switch the channel. Furthermore, the data memory module 16 can record the switching frequency of the channel switching unit 15, the viewer population of the display device 3 and other related data.

The audio/video player 2 comprises a controller 21 respectively connected to a signal transmission module 22, an executing unit 23, an error detecting module 24 and a camera module 25. The controller 21 is a control unit of the audio/video player 2 for receiving the audio/video signal from the signal transmission module 13 of the server host 1 and displaying in the display device 3 by the electrical connection between the executing unit 23 and the display device 3. The detector module 24 can judge or detect whether any error occurred during the audio/video signal transmission in the audio/video player 2. The camera module 25 can capture the image of the viewer standing in front of the display device 3.

A playing command given from the user by pressing the button on the remote controller or directly through the server host 1 is received by the controller 11 and transmitted to the audio/video processor 12, and the audio/video processor 12 processes the command and encodes/decodes to the internal audio/video files at the same time. Then, the signal transmission module 13 transmits the encoded/decoded audio/video signal or channel chosen by the user to the audio/video player through the signal transmission module 22. The signal transmission mode between the signal transmission module 13 and the signal transmission module 22 can be wired or wireless mode. After the audio/video signal is transmitted to the controller 21, the execution unit 23 electrically connected to the display device 3 is employed for displaying or playing the audio/video signal in the display device 3. Thus, the viewer in front of the display device 3 can easily watch the advertisement or the TV program to substantially achieve the commercial activity.

Furthermore, during the audio/video signal transmission, the error detecting module 24 of the audio/video player 2 can judge or detect any error occurred in the audio/video signal received by the signal transmission module 22. However, if the audio/video player 2 cannot normally display the audio/video signal in the display device 3, the signal transmission module 22 will search for the available audio/video signal transmitted by the controller 11 of the server host 1, and the error detecting feedback module 14 receives the error detecting signal transmitted by the audio/video player 2 to report to the controller 11 to make the channel switching unit 15 to promptly switch the channel. Meanwhile, the user can also directly choose or lockup the channel through the channel switching unit 15 of the server host 1, and thereby prevent interruption of the displaying activity even when the audio/video player 2 cannot normally receive or play the audio/video signal, the advertisement or the TV program through the display device 3.

On the other hand, the camera module 25 of the audio/video player 2 is used for capturing the image of the viewer standing in front of the display device 3, Then, the image is transmitted through the signal transmission module 22 and the single transmission module 13 of the server host 1 to the controller 11 for processing the facial feature identification and simulation. Finally, the channel switching unit 15 switches the channel accordingly. Thus the channel can be switched to fit the viewer's feature, such as the age, the sex, the height or other feature, in order to enable the commercial activity in the display device 3 to be more effective.

In addition, the data memory module 16 of the server host 1 records the image captured by the camera module 25 of the audio/video player 2 and the number of the viewers after processing the facial feature identification and simulation by the server host 1, as well as record the switching frequency of the channel switching unit 15 to gain the reference figure of the viewer population and other related data for the market survey.

Furthermore, the server host 1 may comprise a multimedia player including a plurality of audio/video files, such as DVD, VCD or MP3, and the signal transmission modules 13,22 respectively in the server host 1 and the audio/video player 2 may be a public phone network, Internet, a wired transmission interface of DSL (digital subscriber line) or a wireless transmission interface of RF (radio frequency), wireless LAN, IEEE802.15.4, Zigbee or 3G or 3.5G mobile communication network. The camera module 25 may be an image sensor or a CCD (charge-coupled device). The executing unit 23 may communicate with the audio/video player 2 and the display device 3 via wired or wireless communication mode. The display device 3 may be a speaker, a TV set, a projector, a LCD display panel or other device depending on the user's need and purpose and matches with an outdoor advertising media, for example, a TV wall, a display panel, an internal and external display of the car or the commercial bulletin board to increase the effect. Any changes based on the above concept shall be construed to be within the scope of the present invention.

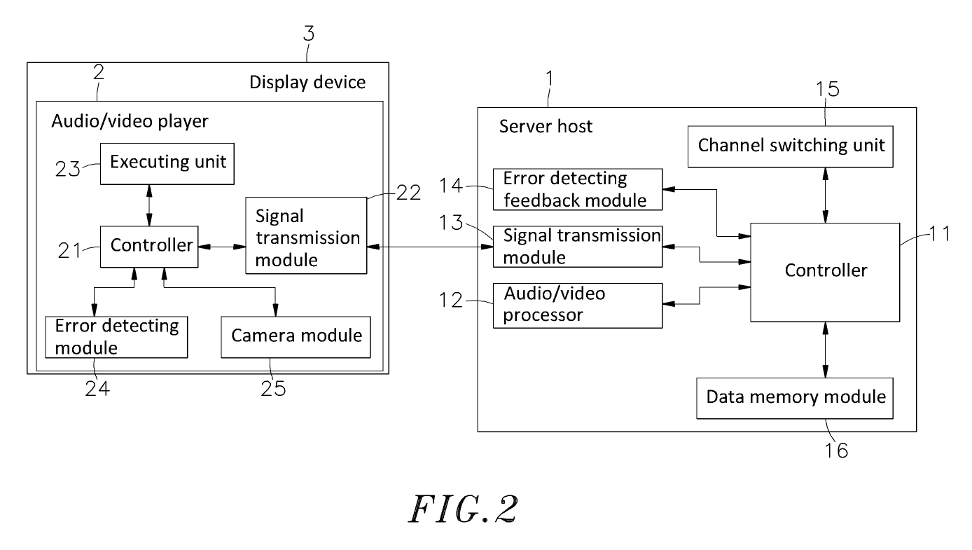

FIG. 2 is a view of a system according to another preferred embodiment of the present invention. Referring to FIG. 2, the above audio/video player 2 can be further built-in on the internal circuit of the display device 3 to display or to play after receiving the audio/video signal. The audio/video player 2 in the display device 3 comprises a controller 21 respectively connected to a signal transmission module 22, an executing unit 23, an error detecting module 24 and a camera module 25. The signal transmission module 22 can receive the audio/video signal transmitted by the signal transmission module 13 of the server host 1; the error detecting module 24 can judge or detect any error occurred during the audio/video signal transmission in the audio/video player 2; the camera module 25 can capture the image of the viewer standing in front of the display device 3. The above description is intended to merely demonstrating the embodiment of the present invention, any alteration or modification thereof to achieve the above purpose of the present invention shall be construed to be within the scope of the present invention.

The embodiment of the present invention described above has at least the following advantages.

1. The error detecting feedback module 14 receives the error signal transmitted by the error detecting module 14 of the audio/video player 2 and reports to the controller 11 to make the channel switching unit 15 promptly switch the channel so as to prevent the problems due to no signal and constantly display in the display device 3.

2. The user can directly choose channel through the channel switching unit 15 of the server host 1 or lockup the audio/video player 2 automatically without communicating with the control room for reset the commercial film or TV program, or the trouble elimination and the bi-directional transmission would not cause any inconvenience and problems.

3. If the user cannot discover the error occurred on time, the channel switching unit 15 can automatically switch the channel to prevent problems due to no signal to display.

4. The audio/video player 2 comprises the camera module 25 to capture the image of the viewer standing in front of the display device 3, and the channel switching unit 15 switches the channel accordingly to fit the viewer's feature, such as the age, the sex, the height or other feature, in order to enable the commercial activity in the display device 3 to be more effective.

5. The server host 1 comprises the data memory module 16 to record the number of the viewer's image captured by the camera module 25 of the audio/video player 2 and the switching frequency of the channel switching unit 15 to gain a reference figure of the viewer population and other related data for the market survey.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A channel switching module, comprising:
a display device;
a server host, comprising a controller for respectively connecting and controlling an audio/video processor, a signal transmission module and a channel switching unit; wherein the audio/video processor encodes/decodes to internal audio/video files, and the channel switching unit switches channels, and the signal transmission module transmits out a selected audio/video signal; and
an audio/video player, comprising a signal transmission module for receiving the audio/video signal transmitted by said server host, and a controller for connecting and controlling an executing unit and the display device for playing.

2. The channel switching module according to claim 1, wherein the controller of the server host is connected to an error detecting feedback module for receiving an error detecting signal transmitted from the=audio/video player.

3. The channel switching module according to claim 1, wherein the controller of the server host is connected to a data memory module for recording a channel switching frequency of the channel switching unit and a number of a viewer population in the front of the display device.

4. The channel switching module according to claim 1, wherein the server host comprises a multimedia player including the audio/video files, such as DVD, VCD or MP3 to coordinate with a TV wall, a display panel, an internal and external display of a car, or a commercial bulletin board to increase advertisement effect.

5. The channel switching module according to claim 1, wherein the signal transmission module of the server host can be a public phone network, Internet, a wired transmission interface of DSL (digital subscriber line) or a wireless transmission interface of RF (radio frequency), wireless Lan, IEEE802.15.4, Zigbee or 3G or 3.5G mobile communication network.

6. The channel switching module according to claim 1, wherein the audio/video player comprises an error detecting module to judge or detect any error occurred during the audio/video signal transmission.

7. The channel switching module according to claim 1, wherein the audio/video player comprises a camera module to capture an image of a viewer positioned in front thereof, and wherein said camera module can be an image sensor or a CCD (charge-coupled device) image sensor.

8. The channel switching module according to claim 1, wherein the executing unit for connecting the display device and the audio/video player can be a speaker, a TV set, a projector or a LCD display panel.

9. The channel switching module according to claim 1, wherein the display device comprises a built-in audio/video player on an internal circuit.
